(19) United States
(12) Patent Application Publication
(10) Pub. No.: US 2008/0063437 A1
(43) Pub. Date: Mar. 13, 2008

(54) DEVELOPER LAYER-REGULATING METHOD AND APPARATUS AND DEVELOPING UNIT AND IMAGE FORMING APPARATUS HAVING THE SAME

(75) Inventor: So-won SHEEN, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/677,604

(22) Filed: Feb. 22, 2007

(30) Foreign Application Priority Data
Sep. 12, 2006 (KR) 2006-88209

(51) Int. Cl. G03G 15/08

(52) U.S. Cl. 399/284

(57) ABSTRACT

A developer layer-regulating method and apparatus and a developing unit and image forming apparatus having the same. The developing unit includes a developing cartridge detachably mounted in a main body of the image forming device and accommodating a developer, a developing member disposed in the developing cartridge to rotate facing a photoconductor, a regulating blade having one end coming in contact with the developing member with a predetermined pressure to regulate a developer layer of the developing member, a supporting bracket disposed in the developing cartridge to support the regulating blade, a heat transferring member disposed on the supporting bracket, a cooling member disposed on the main body to face the heat transferring member and to dissipate heat transmitted from the regulating blade, and an elastic member to elastically support the cooling member so that the cooling member is urged toward the heat transferring member.

### CROSS-REFERENCE TO RELATED APPLICATIONS

This application claims priority under 35 U.S.C. §119(a) of Korean Patent Application No. 10-2006-0088209 filed Sep. 12, 2006, in the Korean Intellectual Property Office, the disclosure of which is hereby incorporated in its entirety by reference.

### BACKGROUND OF THE INVENTION

1. Field of the Invention

The present general inventive concept relates to an image forming apparatus, and more particularly, to a developer layer-regulating method and apparatus, which regulates a developer layer of a developing member in a layer of predetermined thickness, and a developing unit having the developer layer-regulating apparatus.

2. Description of the Related Art

Generally, an image forming apparatus, such as a copier, a printer, a facsimile, and a multifunction machine which performs multiple functions in a single device, is provided with a developing unit which forms a desired image on a printing medium. The developing unit includes a developing cartridge to accommodate a developer, and a developing member disposed in the developing cartridge to develop an electrostatic latent image of a photoconductor.

Such a developing unit has a developer layer-regulating apparatus to regulate a layer of the developer supplied onto the developing member. The developer layer-regulating apparatus usually includes a regulating blade, which comes in contact with the developing member at an end thereof and which is supported by the developing cartridge at the other end thereof.

Recently, to carry out high-speed printing, the developing member is designed to rotate at a high speed. Accordingly, heat is generated by friction between the regulating blade and the developing member, thereby resulting in a low quality development, for example, due to developer solidification. Thus, a way to reduce the heat generated by friction between the regulating blade and the developing member is needed.

As illustrated in FIG. 1, a technique construction, which attaches a heat pipe 4 and a heat radiating pin 5 to a regulating blade 3 to radiate a heat generated between the regulating blade 3 and a developing member 2, is disclosed in Japanese patent publication No. 1996-278696. The regulating blade 3 comes in contact with the developing member 2, which rotates facing a photoconductor 1.

However, the construction as described above presents a problem that whenever a developing cartridge 6 is replaced with a new one, the heat pipe 4 and the heat radiating pin 5 are replaced together with the developing cartridge 6. Also, since the heat pipe 4 is mounted on the regulating blade 3, it may interfere with a laser scan or light exposure to the photoconductor 1.

To address these problems, a method which separately disposes a cooling device, such as a heat pipe, a heat radiating pin, a cooling pan, etc., on a main body of the image forming device to reduce the heat of the regulating blade, can be considered. In this case, however, a heat transfer loss may occur, thereby deteriorating cooling efficiency.

### SUMMARY OF THE INVENTION

The exemplary embodiments of the present general inventive concept address at least the above problems and/or disadvantages and provide at least the advantages described below. Accordingly, the present general inventive concept provides a developer layer-regulating method and apparatus which effectively dissipates heat generated between a regulating blade and a developing member without heat loss and which are semi-permanently used, and a developing unit and image forming apparatus having the developer layer regulating apparatus.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a developer layer-regulating apparatus of an image forming device including a regulating member including a regulating blade having one end to contact a developing member to regulate a developer layer of the developing member, and a supporting bracket to support the regulating blade, a cooling member connectable to a main body of the image forming device to come in contact with the regulating unit and cool heat transmitted from the regulating blade, and an elastic member to elastically support the cooling member to the main body of the image forming device.

The supporting bracket has one end to support the regulating blade and the other end bent from the one end to face the cooling member.

A heat transferring member may be disposed on the other end of the supporting bracket.

A cover may be mounted on the main body to be openable and closable, and the cooling member may be disposed on the cover to move in combination with open and close operations of the cover.

The cooling member may be elastically supported by an elastic member disposed on the cover, so that the cooling member is urged toward the heat transferring member.

The cooling member may include a heat pipe.

The heat transferring member may include a thermal conductive grease applied on the supporting bracket.

A protecting film may be further provided to protect the heat transferring member.

The foregoing and/or other aspects and utilities of the present general inventive concept may also be achieved by providing a developing unit of an image forming device including a developing cartridge detachably mounted in a main body of the image forming device and accommodating a developer, a developing member disposed in the developing cartridge to rotate facing a photoconductor, a regulating blade having one end coming in contact with the developing member in a predetermined pressure to regulate a developer layer of the developing member, a supporting bracket disposed in the developing cartridge to support the regulating blade, a heat transferring member disposed on the supporting bracket, a cooling member disposed in the main body to face the heat transferring member and thus to cool heat transmitted from the regulating blade, and an elastic member to elastically support the cooling member so that the cooling member is urged toward the heat transferring member.

A hole may be formed in the developing cartridge to allow the cooling member and the heat transferring member to come in close contact with each other.

The foregoing and/or other aspects and utilities of the present general inventive concept may also be achieved by providing an image forming apparatus including a main body a developing cartridge removably disposed in the main body and including a cartridge including a developing member to develop an electrostatic latent image on a photoconductive member, and a regulating unit to regulate developer at a predetermined thickness on the developing member, the regulating unit comprising a regulating member to regulate the developer, and a cooling unit disposed on the main body to come in contact with the regulating unit and to dissipate heat transmitted from the regulating member.

The foregoing and/or other aspects and utilities of the present general inventive concept may also be achieved by providing an image forming system including a main body including a cover member to expose an inside thereof, a developing unit detachably insertable into the main body to accommodate a developer, the developing unit including a developing member to deposit the developer on a photoconductive member, a regulating blade to contact and regulate the developer on the developing member at one end and including a heat transferring member connected thereto at another end thereof, and a supporting bracket disposed on the developing unit to support the regulating blade, and a cooling member elastically connectable at one end to the cover member and facing the heat transferring member at another end such that when the cover member is closed the another end of the cooling member comes into pressing contact with the heat transferring member to dissipate heat therefrom.

The foregoing and/or other aspects and utilities of the present general inventive concept may also be achieved by providing a developing unit of an image forming apparatus including a regulating unit to regulate developer at a predetermined thickness on a developing member, the regulating unit including a regulating member to regulate the developer, and a cooling unit to semi-permanently contact the regulating unit to dissipate heat transmitted from the regulating member and which is attached to a door of the image forming apparatus which opens.

The foregoing and/or other aspects and utilities of the present general inventive concept may also be achieved by providing a method of regulating a developer layer in an image forming apparatus, the method including providing a regulating blade of a regulating unit at a predetermined pressure against a developing member to regulate an amount of developer at a predetermined thickness on the developing member, and providing a cooling unit on a main body of the image forming apparatus to be movable into and out of contact with the regulating unit through a hole in the developing cartridge to dissipate heat from the regulating blade.

### BRIEF DESCRIPTION OF THE DRAWINGS

These and/or other aspects and advantages of the embodiments of the present general inventive concept will become apparent and more readily appreciated from the following description of the embodiments, taken in conjunction with the accompanying drawings of which:

FIG. 1 is a cross-sectional view schematically illustrating a developing unit of an image forming device to which a general developer layer-regulating apparatus is applied;

FIG. 2 is a view schematically illustrating a developing unit of an image forming device to which a developer layer-regulating apparatus according to an exemplary embodiment of the present general inventive concept is applied;

FIG. 3 is a view illustrating the developing unit of FIG. 2 when a cover is opened; and

FIG. 4 illustrates a magnified view of the developer layer-regulating apparatus of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

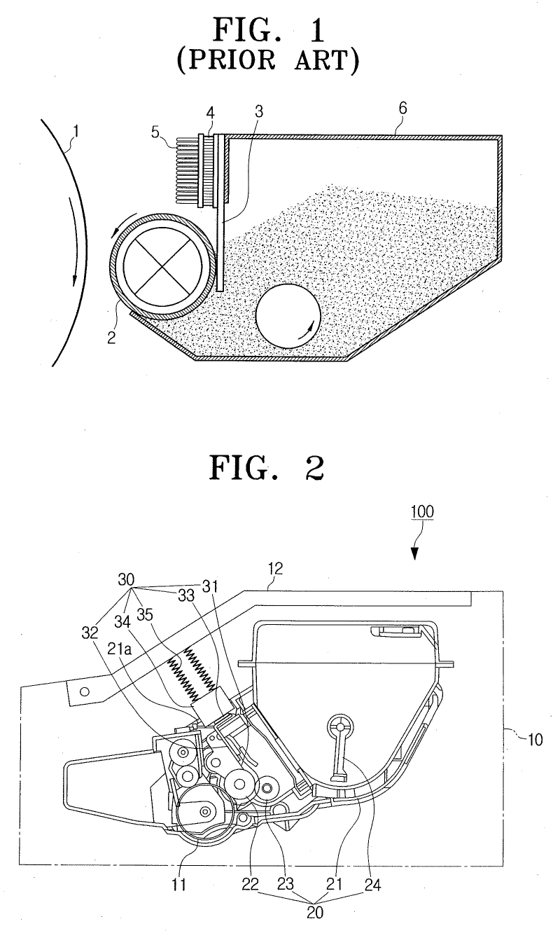

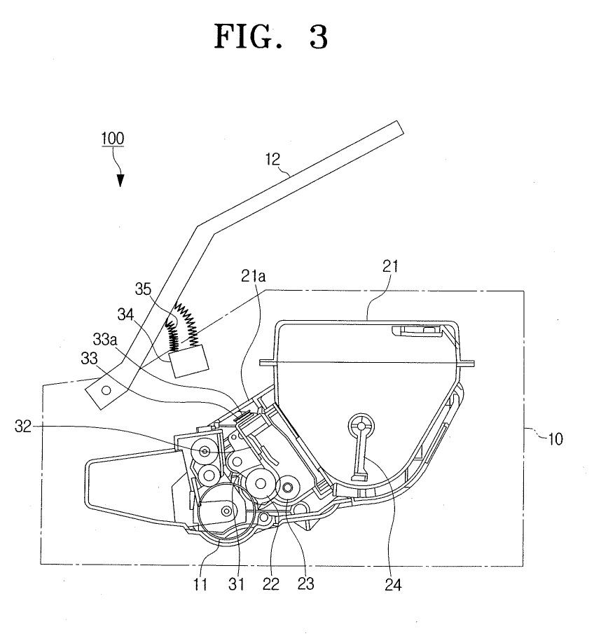

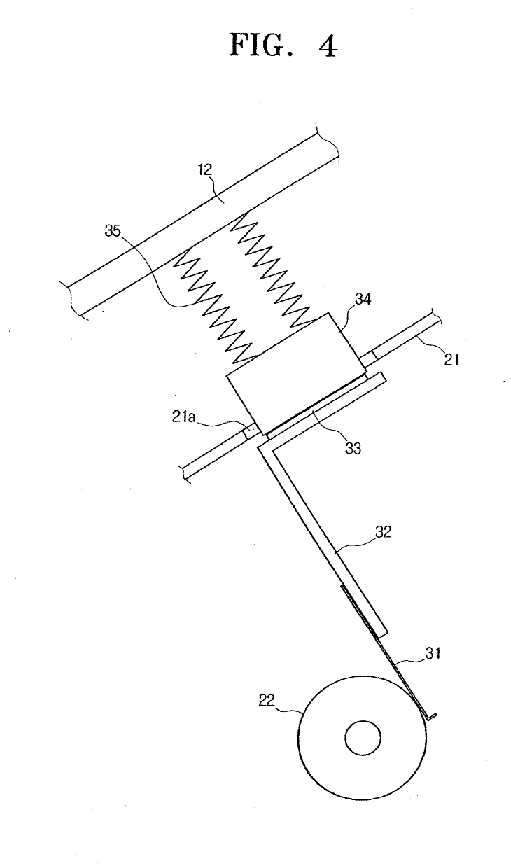

FIGS. 2 and 3 are views schematically illustrating a developing unit 20 of an image forming device 100 to which a developer layer-regulating apparatus 30 according to an exemplary embodiment of the present general inventive concept is applied, and FIG. 4 is a magnified view of the developer layer-regulating apparatus 30 of FIG. 2.

Referring to FIGS. 2 and 3, reference numerals 10 and 11 represent a main body and a photoconductor of the image forming device 100, respectively. The photoconductor 11 is charged with electricity and exposed to light by a charging means (not illustrated) and a laser scanning or light exposing means (not illustrated), respectively, so that an electrostatic latent image is formed thereon.

The electrostatic latent image of the photoconductor 11 is developed by the developing unit 20. The developing unit 20 includes a developing cartridge 21 to accommodate a developer, and a developing member 22 to develop the electrostatic latent image with the developer. The developing member 22 is disposed in the developing cartridge 21 to rotate facing the photoconductor 11.

To be more specific, the developer supplied to the developing member 22 is moved onto the photoconductor 11. As a result, the developer is attached on the electrostatic latent image of the photoconductor 11 to develop the latent image. In FIGS. 2 and 3, reference numeral 23 represents a supplying roller to supply the developer in the developing cartridge 21 to the developing member 22, and a reference numeral 24 represents an agitator to agitate the developer.

The developing unit 20 constructed as described above is configured so that to replace the developing cartridge 21 in which the developer is completely consumed by repeated developing operations, the developing cartridge 21 is detachably mounted in the main body 10. In order to detach and remove the developing cartridge 21, a cover 12 is rotatably disposed on the main body 10 to open and expose an inside thereof.

The developer layer-regulating apparatus 30, which regulates the developer attached on the developing member 22 in a layer of predetermined thickness to form a developer layer on the developing member 22, can include a regulating member 31, a supporting bracket 32, a heat transferring member 33, a cooling member 34, and an elastic member 35.

The regulating member 31 at one end thereof comes in contact with the rotating developing member 22 with a predetermined pressure, and regulates the developer supplied to the developing member 22 in the layer of predetermined thickness. At this time, heat is generated by friction between the one end of the regulating member 31 and the rotating developing member 22. The regulating member 31 may be a regulating blade.

The supporting bracket 32 supports the regulating member 31. Accordingly, the one end and another end of the regulating member 31 form a free end to contact the developing member 22 and a fixed end fixed to the supporting bracket 32, respectively.

The regulating member 31 may be welded and fixed to the supporting bracket 32, and the supporting bracket 32 may be fixed to the developing cartridge 21 by screws.

Also, the supporting bracket 32 has one end to support the regulating member 31 and the another end bent from the one end to have a side thereof face the cooling member 34 to be described in detailed later. The another end of the supporting bracket 32 may be bent in a direction pointing away from an installation location of the photoconductor 11. With this construction, the cooling member 34 does not interfere with a laser scan or light exposure to the photoconductor 11. For example, while the photoconductor 11 may be disposed at one side of the regulating member 31, the supporting bracket 32 may bend toward a same direction as an opposite side of the regulating member 31 with respect to the one side thereof.

The heat transferring member 33, which transfers the heat generated between the regulating member 31 and the developing member 22 away from the regulating member 31 and support bracket 32, is disposed on the another end of the supporting bracket 32. The heat transferring member 33 may be made up of a thermal conductive grease applied on the another end of the supporting bracket 32.

Since the heat transferring member 33 is disposed on the supporting bracket 32 installed in the developing cartridge 21 at the side of the supporting bracket 32 facing the cooling member 34, the heat transferring member 33 may be replaced along with the developing cartridge 21 in a replacement of the developing cartridge 21. Accordingly, in the replacement of the developing cartridge 21, to prevent a user from coming in contact with the heat transferring member 33, a protecting film 33a (see FIG. 3) may be attached on the heat transferring member 33. The protecting film 33a may be removed prior to mounting the developing cartridge 21 in the main body 10.

The heat transferring member 33 constructed as described above, and the another end of the supporting bracket 32 which faces the cooling member 34 and supports the heat transferring member 33, are formed as wide as possible to take into account a heat transfer efficiency.

The cooling member 34 is disposed in the main body 10 to come in close contact with the heat transferring member 33 of the supporting bracket 32 and thus to cool the heat transmitted from the regulating member 31. For this, a hole 21a is formed in the developing cartridge 21 to allow the cooling member 34 and the heat transferring member 33 to come in close contact with each other. That is, the cooling member 34 comes in close contact with the heat transferring member 33 disposed in the developing cartridge 21 through the hole 21a.

The cooling member 34 is disposed on the cover 12 to move in combination with open and close operations of the cover 12. Also, the cooling member 34 is elastically urged toward the heat transferring member 33 by the elastic member 35 disposed on the cover 12, so that it comes in close contact with the heat transferring member 33.

As described above, the cooling member 34 is disposed in the main body 10 so as not to interfere with the replacement operation of the developing cartridge 21. Accordingly, the cooling member 34 can be semi-permanently used.

In the exemplary embodiment of the present general inventive concept, the cooling member 34 is illustrated and explained as moving in combination with the open and close operations of the cover 12, but the present general inventive concept is not limited thereto. That is, the cooling member 34 can be modified, so that it is disposed to the main body 20 to be elastically urged toward the heat transferring member 33 by the elastic member 35 in combination with the replacement operation of the developing cartridge 21 or a developing or printing command signal inputted by the user.

The cooling member 34 constructed as described above may be made up of a heat pipe. The heat pipe, as a vacuum airtight container, includes an evaporation part, a condensation part and an adiabatic part, which are disposed in a longitudinal direction. With this construction, the cooling member 34 made up of the heat pipe can radiate heat by itself without external power. Accordingly, the cooling member 34 can be semi-permanently used.

In the exemplary embodiment of the present general inventive concept, the cooling member 34 is illustrated and explained as the heat pipe, but the present general inventive concept is not limited thereto. That is, the cooling member 34 can be made up of any one of various cooling devices, such as a cooling pan, a radiating pin, etc., which are semi-permanently usable.

Hereinafter, an operation of the developing unit 20 having the developer layer-regulating apparatus 30 constructed as described above will be described in detail with reference to FIGS. 2 through 4.

As illustrated in FIG. 2, the developing cartridge 21 mounted in the main body 10 develops an electrostatic latent image of the photoconductor 11. At this time, a developer is supplied to the developing member 22 from the supplying roller 23. The regulating member 31 comes in contact with the developer supplied to the developing member 22 with a predetermined pressure, and thus regulates the developer in a layer of predetermined thickness. Here, heat is generated by friction between the rotating developing member 22 and the regulating member 31, and is transmitted to the supporting bracket 32, which supports the regulating member 31.

The heat transmitted to the supporting bracket 32 is transferred to and cooled by the cooling member 34 through the heat transferring member 33. At this time, the cooling member 34 is elastically urged by the elastic member 35 to come in close contact with the heat transferring member 33 through the hole 21a. Accordingly, when a contact force between the cooling member 34 and the heat transferring member 33 is increased by the elastic member 35, a heat transfer efficiency of the heat transferring member 33 in response to the heat generated from the regulating member 31 is improved.

If the developing cartridge 21 needs to be replaced with a new one due to consumption of the developer accommodated in the developing cartridge 21, as illustrated in FIG. 3, an inside of the main body 10 is exposed by rotating the cover 12 to an open position. At this time, the cooling member 34 disposed on the cover 12 is moved in combination with the open operation of the cover 12, and releases a contact or pressing force on the heat transferring member 33. As a result, the cooling member 34 does not interfere with the replacement operation of the developing cartridge 21 when the developing cartridge 21 is replaced with a new one.

As apparent from the foregoing description, according to the exemplary embodiments of the present general inventive concept, the developer layer-regulating apparatus and the developing unit and image forming apparatus having the developer layer-regulating apparatus are configured so that the heat transferring member is disposed on the supporting bracket supporting the regulating blade and the heat transferring member and the cooling member are in close contact with each other. Accordingly, cooling efficiency can be improved without a direct loss of the heat generated from the regulating blade.

Also, the developer layer-regulating method and apparatus according to exemplary embodiments of the present general inventive concept and the developing unit and image forming apparatus having the developer layer-regulating apparatus are configured so that the cooling member is not disposed in the developing cartridge to be replaced, but is disposed on the main body separately from the developing cartridge. Accordingly, the cooling member can be semi-permanently used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developer layer-regulating apparatus of an image forming device comprising:
a regulating member including:
a regulating blade having one end to contact a developing memberto regulate a developer layer of the developing member, and
a supporting bracket to support the regulating blade;
a cooling member connectable to a main body of the image forming device to come in contact with the regulating unit and cool heat transmitted from the regulating blade; and
an elastic member to elastically support the cooling member to the main body of the image forming device.

2. The apparatus of claim 1, wherein the supporting bracket has one end to support the regulating blade and another end bent from the one end to face the cooling member.

3. The apparatus of claim 2, further comprising a heat transferring member disposed on the another end of the supporting bracket.

4. The apparatus of claim 3, wherein a cover is mounted on the main body to be openable and closable, and the cooling member is disposed on the cover to move in combination with open and close operations of the cover.

5. The apparatus of claim 4, wherein the cooling member is elastically supported by the elastic member disposed on the cover, so that the cooling member is urged toward the heat transferring member.

6. The apparatus of claim 1, wherein the cooling member comprises a heat pipe.

7. The apparatus of claim 3, wherein the heat transferring member comprises a thermal conductive grease applied on the supporting bracket.

8. The apparatus of claim 7, further comprising:
a protecting film to protect the heat transferring member.

9. A developing unit of an image forming device comprising:
a developing cartridge detachably mounted in a main body of the image forming device and accommodating a developer;
a developing member disposed in the developing cartridge to rotate facing a photoconductor;
a regulating blade having one end coming in contact with the developing member with a predetermined pressure to regulate a developer layer of the developing member;
a supporting bracket disposed in the developing cartridge to support the regulating blade;
a heat transferring member disposed on the supporting bracket;
a cooling member disposed on the main body to face the heat transferring member and to cool heat transmitted from the regulating blade; and
an elastic member to elastically support the cooling member so that the cooling member is urged toward the heat transferring member.

10. The unit of claim 9, wherein the main body has a cover to replace the developing cartridge, and the cooling member is disposed on the cover to move in combination with open and close operations of the cover.

11. The unit of claim 10, wherein the elastic member is disposed on the cover.

12. The unit of claim 9, wherein the supporting bracket has one end to support the regulating blade and another end bent from the one end to support the heat transferring member.

13. The unit of claim 12, wherein the heat transferring member comprises a thermal conductive grease applied on the supporting bracket.

14. The unit of claim 13, further comprising:
a protecting film to protect the heat transferring member.

15. The unit of claim 9, wherein a hole is formed in the developing cartridge to allow the cooling member and the heat transferring member to come in close contact with each other.

16. The unit of claim 9, wherein the cooling member comprises a heat pipe.

17. An image forming apparatus comprising:
a main body;
a developing cartridge removably disposed in the main body and including a cartridge comprising:
a developing member to develop an electrostatic latent image on a photoconductive member, and
a regulating unit to regulate developer at a predetermined thickness on the developing member, the regulating unit comprising a regulating member to regulate the developer; and
a cooling unit disposed on the main body to come in contact with the regulating unit and to dissipate heat transmitted from the regulating member.

18. The image forming apparatus of claim 17, wherein the cooling unit comprises:
a cooling member to dissipate heat from the regulating unit;
an elastic member to elastically support the cooling member on the main body and to press the cooling member into contact with the regulating unit.

19. The image forming apparatus of claim 18, wherein the cooling member is one of a cooling pan, a radiating pin, and a heat pipe.

20. The image forming apparatus of claim 18, wherein further comprising:
a cover attached to the main body and movable between an open position and a closed position,
wherein the cooling unit is disposed on the cover to press the cooling member towards the regulating unit with a predetermined force in the closed position and to allow the developing cartridge to be removed in the open position.

21. The image forming apparatus of claim 17, wherein the regulating unit further comprises:
a heat transfer member to transfer heat from the regulating member.

22. The image forming apparatus of claim 17, wherein the developing cartridge further comprises:
a hole to allow the cooling unit to contact the regulating unit to dissipate the heat from the regulating member.

23. The image forming apparatus of claim 17, wherein the regulating unit further comprises a supporting bracket to support the regulating member and to transfer heat from the regulating member.

24. The image forming apparatus of claim 23, wherein the regulating member is a regulating blade and is welded to the supporting bracket, and wherein the supporting bracket is fixed to the developing cartridge by screws.

25. The image forming apparatus of claim 23, wherein the supporting bracket is bent in an opposite direction from a photoconductor of the image forming apparatus to prevent the cooling unit from interfering with image forming.

26. An image forming system, comprising:
a main body including a cover member to expose an inside thereof;
a developing unit detachably insertable into the main body to accommodate a developer, the developing unit including:
a developing member to deposit the developer on a photoconductive member,
a regulating blade to contact and regulate the developer on the developing member at one end and including a heat transferring member connected thereto at another end thereof, and
a supporting bracket disposed on the developing unit to support the regulating blade; and
a cooling member elastically connectable at one end to the cover member and facing the heat transferring member at another end such that when the cover member is closed the another end of the cooling member comes into pressing contact with the heat transferring member to dissipate heat therefrom.

27. The image forming system of claim 26, wherein the cooling member is connected at the one end to the cover member via an elastic member.

28. The image forming system of claim 26, wherein the another end of the regulating blade is bent toward a first side thereof to extend away from a second side of the one end that contacts the developing member.

29. A developing unit of an image forming apparatus, comprising:
a regulating unit to regulate developer at a predetermined thickness on a developing member, the regulating unit including a regulating member to regulate the developer; and
a cooling unit to semi-permanently contact the regulating unit to dissipate heat transmitted from the regulating member and which is attached to a door of the image forming apparatus which opens.

30. A method of regulating a developer layer in an image forming apparatus, the method comprising:
providing a regulating blade of a regulating unit at a predetermined pressure against a developing member to regulate an amount of developer at a predetermined thickness on the developing member; and
providing a cooling unit on a main body of the image forming apparatus to be movable into and out of contact with the regulating unit through a hole in the developing cartridge to dissipate heat from the regulating blade.

31. The method of claim 30, wherein the urging of the cooling unit comprises:
elastically urging the cooling unit against the regulating unit by providing an elastic member between the cooling unit and the main body of the image forming apparatus.
